(19) United States
(12) Patent Application Publication
(10) Pub. No.: US 2008/0151991 A1
(43) Pub. Date: Jun. 26, 2008

(54) SYSTEM AND METHOD FOR IMPLEMENTING IMPROVED ZOOM CONTROL IN VIDEO PLAYBACK

(75) Inventors: Mejdi Trimeche, Tampere (FI); Sami Vaskuu, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/615,597

(22) Filed: Dec. 22, 2006

(51) Int. Cl. H04N 11/02; H04N 7/26

(52) U.S. Cl. 375/240.01; 386/124; 375/E07.076

(57) ABSTRACT

A system and method for enabling improved zoom control during the playback of a video. In various embodiments, a video player includes an improved dynamic user interface which UI enables a user to zoom into high resolution images whenever the “pause” button is pressed on the video player. Various embodiments also provide for the use of improved algorithms for image interpolation. These algorithms involve the utilization of a sequence of adjacent video frames so that the spatial resolution of the current frame can be enhanced. These algorithms may also at least selectively take advantage of high-resolution still images that exist in media content containing merged video and still images.

### FIELD OF THE INVENTION

The present invention relates generally to use of video players on electronic devices such as mobile telephones. More particularly, the present invention relates to the use of zoom control during video playback on electronic devices.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In recent years, the incorporation of video players on electronic devices has increased significantly. Video players are typically identified as media players which are capable of playing back to a user digital video data from computer hard drives, DVD's, and other storage media. Video players are often capable of playing media stored in a variety of formats, including the MPEG, AVI, RealVideo, and QuickTime formats.

As video players become more commonplace on electronic devices, users are increasingly demanding that video players become easier to use and be capable of seamlessly implementing more complex actions. For example, many users often wish to pause on a certain frame of a video in order to more closely examine the content in the image. This closer examination may include zooming into a particular portion of the images. However, conventional video players typically either do not permit any sort of zooming or require a relatively complex and nonintuitive process for performing the zooming action. For example, many video players only include easy-to-access buttons for a limited number of commonly used features (i.e., “play,” “pause,” “stop,” “forward,” and “reverse”) and instead require a user to access a drop-down menu to locate a “zoom” feature, which is a fairly time-consuming process.

In addition to the above, when the video player is located on a mobile device such as a mobile telephone, the use of such menus can be difficult to implement. In addition to the above, although many video players support some form of zooming feature, zooming into images played therein typically does not result in any substantial improvement in resolution. For example, some video players simply replicate individual pixels or perform some other similar “zero order” interpolation technique during a zooming process, and these techniques do little to improve the resolution for a user. In addition, video players increasingly must be capable of processing and using new forms of content for use in video capture.

It would therefore be desirable to provide a video player that includes a zooming function that is easier to implement by a user, as well as a player that provides an improved picture quality when zooming is implemented. It would also be desirable for the video player to easily process and utilize new forms of media content.

### SUMMARY OF THE INVENTION

Various embodiments of the present invention provide a video player including an improved dynamic user interface (UI). This UI enables a user to zoom into high resolution images whenever the “pause” button is pressed on the video player. In addition, various embodiments provide for the use of improved algorithms for image interpolation. These algorithms involve the utilization of a sequence of adjacent video frames so that the spatial resolution of the current frame can be enhanced. In various embodiments, a media player can at least selectively take advantage of high-resolution still images that exist in media content containing merged video and still images, thereby rendering a high quality image without having to interpolate the image from video frames.

Various embodiments of the present invention provide for a UI that is both simple and intuitive in the context of video playback, and also enable improved systems for video and image capture. Additionally, the improved image capture mechanism of the various embodiments also makes it easier to enable the printing of images that are captured from a video item.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a depiction of a merged media content item containing a combination of video content, audio content, and still images;

FIG. 2(a) is a representation of a user interface for media player during the process of playing a media item; and FIG. 2(b) shows the same user interface, when the user is using a zoom tool in accordance with an embodiment of the present invention;

FIG. 3 is a chart depicting various user interface states for a media player when playing a media item in accordance with various embodiments of the present invention;

FIG. 4 is a chart depicting various Series 60 (S60) user interface states for a media player when playing a media item;

FIG. 5 is a flow chart showing a process by which a still image is displayed to a user according to one embodiment of the present invention;

FIG. 6 is flow chart showing a process by which an index of an image can be obtained based upon a current timestamp from a paused media image;

FIG. 7 is a flow chart depicting the processes by which a still image is captured or generated from a media item, as well as how the still image is zoomed in accordance with embodiments of the present invention;

FIG. 8 is a representation of a generic video decoder with which the present invention may be implemented;

FIG. 9 is a chart showing how frames are extracted for super-resolution generation according to various embodiments of the present invention;

FIG. 10 is a depiction showing how super-resolution of an object in a media item occurs;

FIG. 11 is a perspective view of a mobile telephone that can be used in the implementation of the present invention; and

FIG. 12 is a schematic representation of the telephone circuitry of the mobile telephone of FIG. 11.

### DETAILED DESCRIPTION OF THE PREFERRED EMBODIMENTS

Video players increasingly must be capable of processing and using new forms of content for use in video capture. For example, the merging of video and still image capture into a single application is expected to become increasingly important in the future. Conventionally, when an event is being recorded, a user must make a choice as to whether still pictures or video should be captured, and each has its own advantages and disadvantages. On the one hand, still images are easy to capture and view (with a high image quality), but they also provide only a static snapshot of a scene. On the other hand, video better captures the “atmosphere” of a scene and provides richer emotional context, but the resulting picture quality is low and the processor power and memory requirement for preserving video is high. The merging of video and still images serves to take advantage of the benefits of both media types.

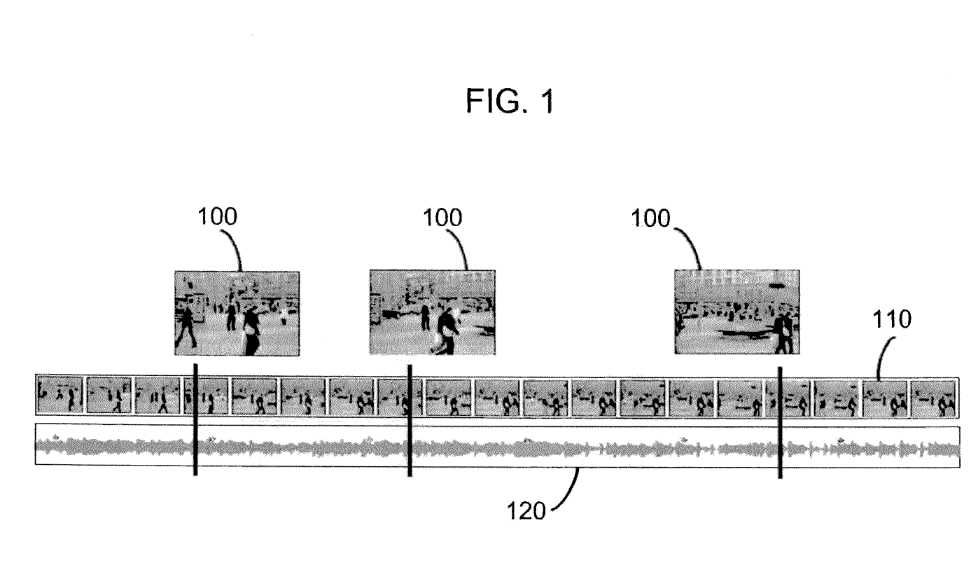

An example of the merging of video content and still images is depicted in FIG. 1. As shown in FIG. 1, a media content item constructed according to this format includes still images 100, video 110 and audio 120. When a device's camera application is activated, the device continuously records the video 110 and the audio 120. When an “image capture” button is actuated, a higher resolution still image 100 is captured and stored sequentially relative to the surrounding video 110 and audio 120. In certain implementations, when viewing one of the still images 100, the user may also be able to view the video 110 and listen to the audio 120 immediately before and after the moment when the still image 100 was taken.

Various embodiments of the present invention provide a video player including an improved dynamic user interface (UI). This UI enables a user to zoom into high resolution images whenever the “pause” button is pressed on the video player. In addition, various embodiments provide for the use of improved algorithms for image interpolation. These algorithms involve the utilization of a sequence of adjacent video frames so that the spatial resolution of the current frame can be enhanced. In various embodiments, a media player can at least selectively take advantage of high-resolution still images that exist in media content containing merged video and still images, thereby rendering a high quality image without having to interpolate the image from video frames.

FIG. 2(a) is a representation of a UI 200 for a media player within which various embodiments of the present invention may be implemented. In addition to a viewing window 210, the UI 200 includes a “Previous” button 220, the actuation of which can move the media player to a prior track or selection in a play list, a “Rewind” button 230, a “Pause” button 240, a “Forward” button 250, and a “Next” button 260, which can be used to select a subsequent track or selection in a play list. These controls are used to control video playback when the media player is in a video playback state.

FIG. 2(b) shows the same UI 200 when the user is using a zoom tool in accordance with an embodiment of the present invention. As shown in FIG. 2(b), when the user presses the pause button 240, the UI 200 shifts to another state which permits the user to zoom in the still picture which is shown in the viewing window 210 when the video is stopped. In the paused state, in addition to the “Previous” button 220 and the “Next” button 260, three new controls are available, as represented by a “Zoom Out” button 270, a “Play” button 280, and a “Zoom In” button 290. The “Play” button 280 reactivates the video playback state and continues the video playback from the previous position.

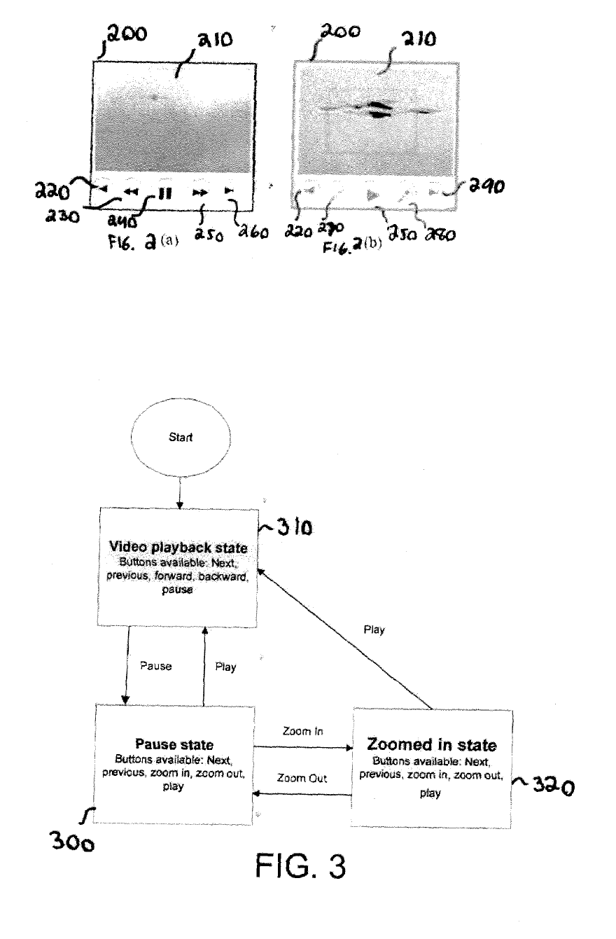

FIG. 3 shows the interactions between a simple paused state 300, a video playback state 310, and a zoomed in state 320 for the media player. The state shown in FIG. 2(b) is the paused state 300, with the picture zoomed out. In this case, the “Zoom Out” button 270 is grayed out in one embodiment and is not actuable by the user. When the user activates the “Zoom In” button 290, the UI 200 shifts to the zoomed in state 320 and performs zooming according to one of various algorithms. These algorithms can include indexing algorithms and interpolation algorithms, both of which are discussed below. The zoomed in state 320 is similar to the paused state 300, except that the “Zoom Out” 270 button is enabled. Clicking on the “Zoom Out” 270 button when in the zoomed in state 320 will zoom out the picture or, if the picture is fully zoomed out, the UI 200 will switch to the paused state 300 and disable the “Zoom Out” 270 button. As shown in FIG. 3, actuation of the “Play” button 240 when in the zoomed in state 320 or the paused state 300 causes the media player to enter the video playback state 310.

As shown in FIG. 2(b), it is also possible to select the desired region for zooming in various embodiments of the present invention. For example, the UI 200 of FIGS. 2(a) and 2(b) can comprise a “pen input” UI, where a user can use a stylus or similar device to draw a rectangle 295, which in turn defines a region of interest (ROI). In one particular embodiment, the lifting of the pen or stylus causes the ROI to zoom to a full screen. If the user touches the screen when in video playback mode 310, then the media player can automatically activate the paused state 300, permitting the user to draw rectangle 295. The various control buttons are drawn on the screen so that the user can activate them using the pen or stylus.

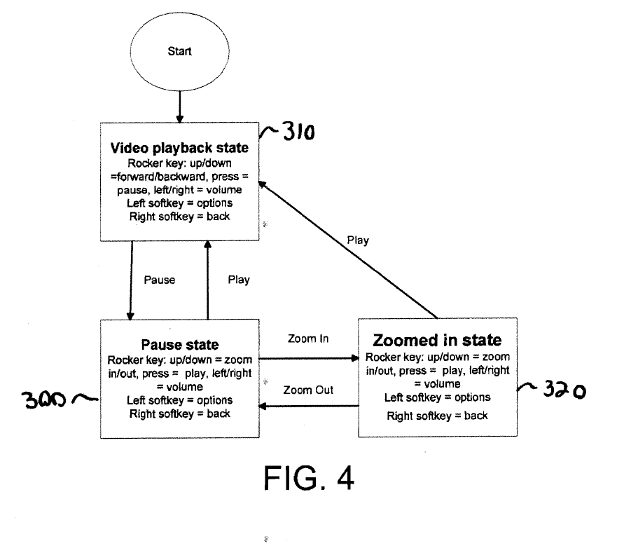

In addition a “pen input” UI, the UI 200 can also operate in conjunction with other input mechanisms. For example, one such interface does not include any on-screen buttons and instead includes a pair of softkeys, a “rocker key” context menu, and an options menu. This interface is used, for example on many devices incorporating the S60 software developed by Nokia Corporation. FIG. 4 shows the various UI states and available options for a device incorporating this system. Like the prior UI 200 discussed above, this system can include a paused state 300, a video playback state 310, and a zoomed in state 320. However, the respective inputs required for various actions are different. When in the paused state 300 or the zoomed in state 320, up and down movements of the rocker key result in the zooming in and out of the image at issue. Pressing the rocker key results in the media item being played, returning the player to the video playback state 310. When in the video playback state 310, the movement of the rocket key results in moving forward or backward within the video. In any of the states, moving the rocker key to the left and right adjusts the volume of the media item, pressing the left soft key activates the options menu for use, and pressing the right soft key results in a “back” action.

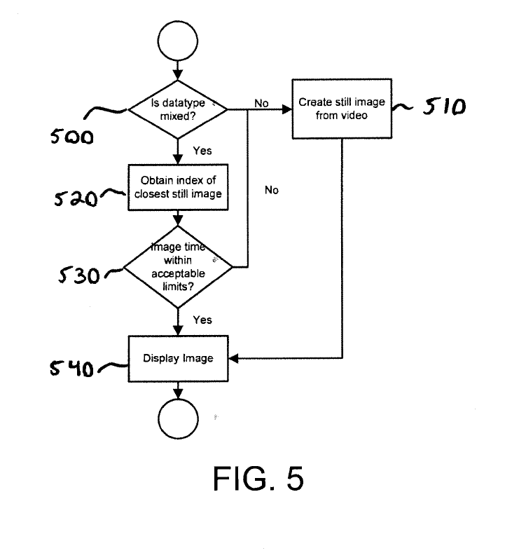

FIG. 5 is a flow chart showing how a media player can obtain and/or create a high quality still image from a media item for use in subsequent zooming according to various embodiments of the present invention. Once the still image is obtained, the image can be exhibited to the user and used for zooming purposes. At 500 in FIG. 5, the system first determines if the media item is of a mixed data type, i.e., whether the media item includes both video and independent still images (as depicted in FIG. 1). If the data type is not mixed, then the system creates a still image from the associated video at 510. If, on the other hand, the media item is of a mixed data type, then the system proceeds to obtain an index of the closest still image at 520 (i.e., the still image closest in time to when the point where the media item was paused). At 530, it is then determined whether the time of the image within the media item is within acceptable predefined limits. If not, then the system decides not to use the selected image and instead creates an image from the video at 510. If the selected image is within acceptable time limits, however, then at 540 the selected image is displayed to the user and is usable for zooming functions.

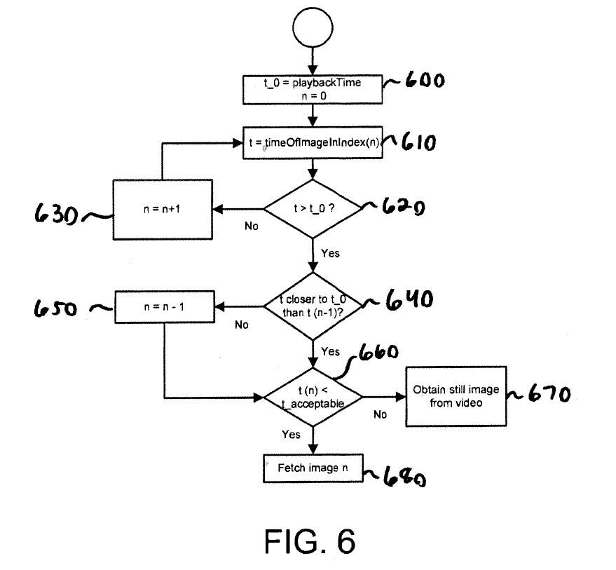

FIG. 6 is a flow chart showing a process by which an index of an image can be obtained based upon a current timestamp from a paused media image. At 600 in FIG. 6, t_0 is designated as the current playback time (where the video was paused) and n is set to 0. At 610, t is set to be equal to the time of still image(n) in an index of still images contained in the media item. At 620, it is determined whether t is greater than t_0. If not, then n is incremented by one at 630 and processes 610 and 620 are repeated. If on the other hand, t is greater than t_0 (meaning that the particular image occurs later in time than the current playback time), it is then determined at 640 whether t is closer to t_0 than the time for the previous indexed image (t(n−1)). If not, then n is decremented by 1 at 650 and process 640 is repeated. If t is closer to t_0 than the time for the previous indexed image, it is then determined at 660 whether the selected t(n) is less than an acceptable threshold time, which can be predefined. If not, then the system creates a still image from the video instead of using the indexed image at 670. This serves as a fallback mechanism so that a higher quality image can still be obtained if no acceptable still image is present. If t(n) is less than the threshold time, then the image at t(n) is fetched for exhibition and potential zooming at 680.

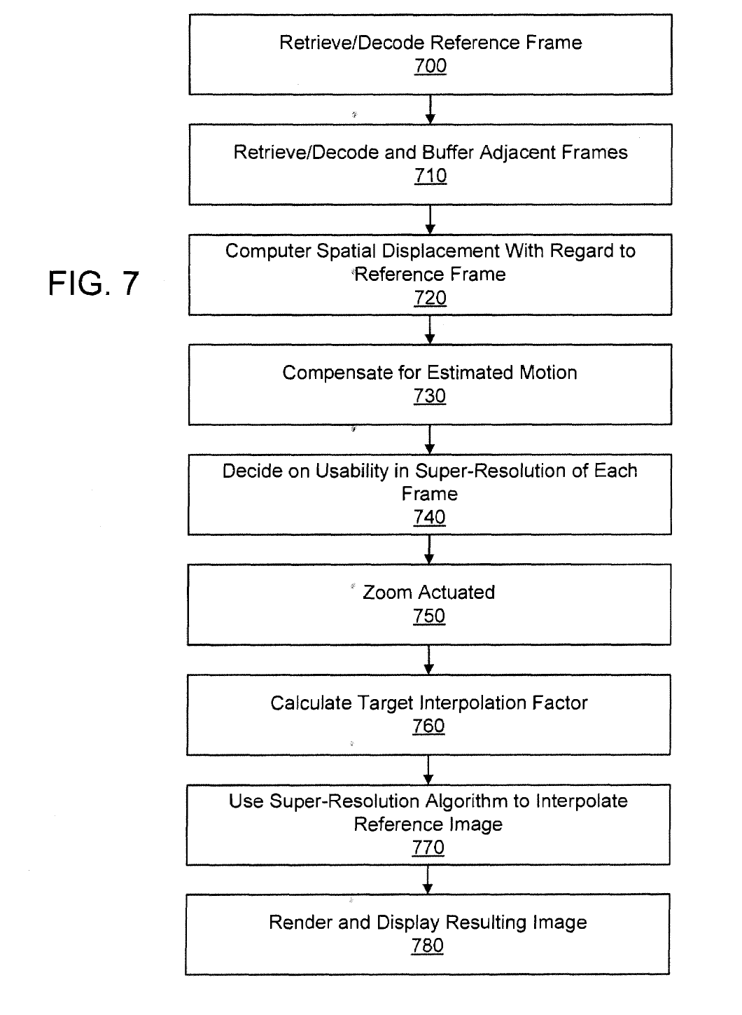

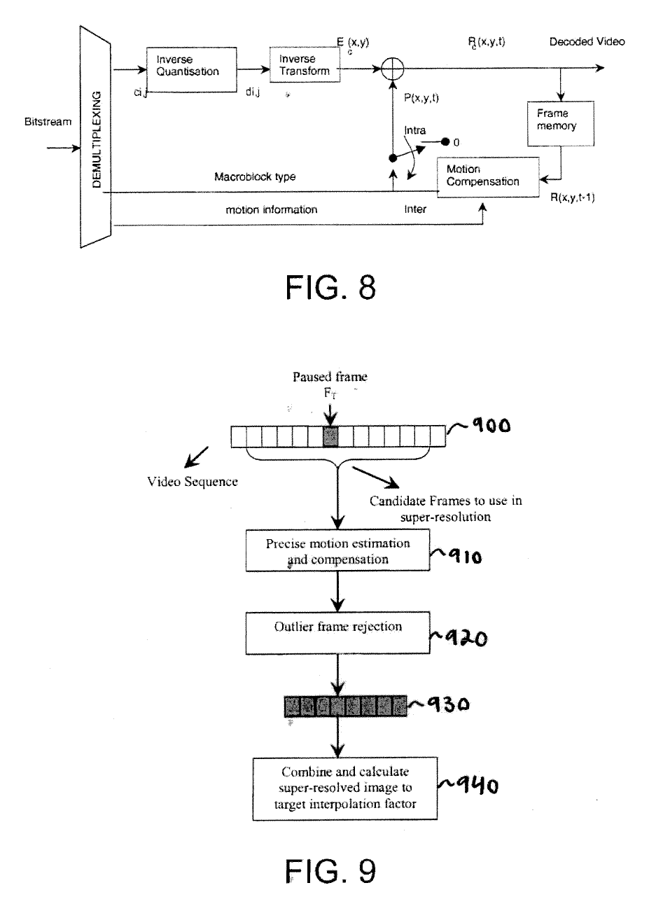

FIG. 7 is a flow chart showing a process by which an interpolation algorithm can be used to create a still image from video for use in zooming, as well as the how the zooming function of an image is implemented. At 700 in FIG. 7, when the video or media player is paused, a reference frame F_{T} is retrieved/decoded from the compressed video stream. A generic decoder capable of performing this process is depicted in FIG. 8. At 710, temporally adjacent frames (e.g., F^{T-M}, F_{T-M+1}, . . . F_{T}, . . . F_{T+M}, . . . F_{T+M}) are retrieved/decoded and buffered. At 720, for each of the buffered frames, a motion estimation algorithm is applied in order to compute a spatial displacement level relative to the reference frame F_{T}. At 730, for each buffered frame, the system compensates for the estimated motion using enhanced interpolation (e.g., using Gaussian interpolators). The system also calculates an associated mean square error (MSE) for each frame. At 740, the system determines how “usable” each frame for use in creating a super-resolution (SR) image of the reference frame. This usability can be based upon, for example, a relative threshold value of the MSE for the particular frame. Frames not meeting this threshold can be discarded and not used in subsequent zooming actions.

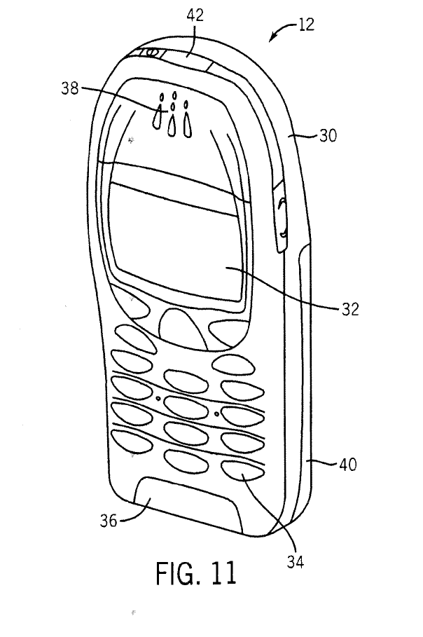

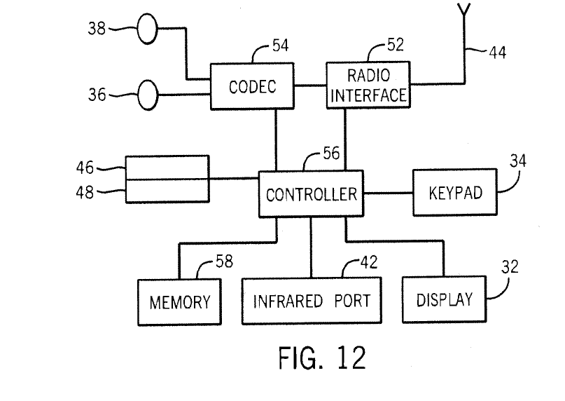

At 750 in FIG. 7, the user presses a “Zoom In” button. In response, a target interpolation factor is calculated at 760. This can be based, for example, on the user's prior zooming history. At 770, a SR algorithm is applied in order to interpolate the reference image. The SR algorithm can use the stored images meeting acceptable criteria and the various parameters depicted at 720 and 730 for those images in order to perform this interpolation. Such super-resolution processing is graphically depicted in FIG. 10. Once the interpolation is complete, the resulting image is displayed to the user at 780.

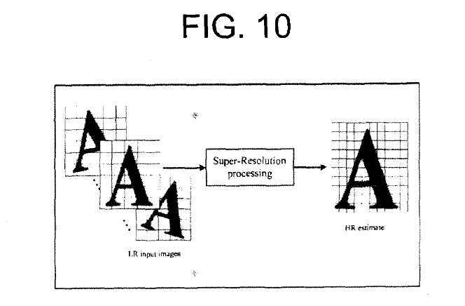

FIG. 9 is a flow chart showing in detail how frames are extracted for SR generation. 900 in FIG. 9 represents a plurality of video sequence frames in the vicinity of the selected reference frame FT. These frames comprise the candidate frames for potential use in super-resolution. The precise number of candidate frames may vary depending upon system requirements and preferences. This is followed by precise motion estimation and compensation, collectively represented at 910. At 920, “outlier” frames deemed not suitable for super-resolution are rejected, resulting in a subset of acceptable candidate frames, which are represented at 930. Later, the acceptable candidate frames can be combined and a super-resolved image can be calculated at 940 to a target interpolation factor.

FIGS. 10 and 11 show one representative mobile telephone 12 within which the present invention may be implemented. It should be understood, however, that the present invention is not intended to be limited to one particular type of mobile telephone 12 or other electronic device. The mobile telephone 12 of FIGS. 10 and 11 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56, a memory 58 and a battery 80. Individual circuits and elements are all of a type well known in the art, for example in the Nokia range of mobile telephones.

Communication devices of the present invention may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of implementing zooming capabilities on a media player, comprising:
providing a user interface that permits a user to manipulate video using a plurality of input mechanisms, each of the plurality of input mechanisms associated with a predetermined function;
during the playing of a video item in a video playback state, processing a received pause input instruction through one of the input mechanisms;
in response to the pause input instruction, replacing the predetermined function for one of the plurality of input mechanisms with a zooming function.

2. The method of claim 1, wherein the plurality of input mechanisms comprise a plurality of user-actuable buttons appearing on the user interface.

3. The method of claim 1, wherein the plurality of input mechanisms include a plurality of user-actuable keys.

4. The method of claim 1, wherein, in response to the pause input instruction, the user interface moves to a paused state, and wherein the first zooming function permits a user to zoom into a portion of the video.

5. The method of claim 4, wherein, when the zooming function is actuated, the user interface moves to a zoomed in state, and wherein a zooming out function is associated with one of the plurality of input mechanisms when the user interface is in the zoomed in state.

6. A computer program product, embodied in a computer-readable medium, comprising computer code for performing the processes of claim 1.

7. An apparatus, comprising:
a processor; and
a memory unit communicatively connected to the processor and including:
computer code for providing a user interface that permits a user to manipulate video using a plurality of input mechanisms, each of the plurality of input mechanisms corresponding to a predetermined function;
computer code for, during the playing of a video item in a video playback state, processing a received pause input instruction through one of the input mechanisms; and
computer code for, in response to the pause input instruction, replacing the predetermined function for one of the plurality of input mechanisms with a zooming function.

8. The apparatus of claim 7, wherein the plurality of input mechanisms comprise a plurality of user-actuable buttons appearing on the user interface.

9. The apparatus of claim 7, wherein the plurality of input mechanisms include a plurality of user-actuable keys.

10. The apparatus of claim 7, wherein, in response to the pause input instruction, the user interface moves to a paused state, and wherein the first zooming function permits a user to zoom into a portion of the video.

11. The apparatus of claim 10, wherein, when the zooming function is actuated, the user interface moves to a zoomed in state, and wherein a zooming out function is associated with one of the plurality of input mechanisms when the user interface is in the zoomed in state.

12. A method of obtaining a zoomable image from a media item including video content, comprising:
upon receiving a designated instruction during the playing of the media item, determining whether the media item includes still images in addition to the video content;
if the media item does not include still images, creating and rendering the zoomable image from the video content;
if the media item includes still images, identifying a still image that most closely corresponds in time to the time in the media item at which the designated instruction was received,
determining whether the identified still image satisfies an acceptable time constraint;
if the identified still image satisfies the acceptable time constraint, rendering the identified still image as the zoomable image; and
if the identified still image does not satisfy the acceptable time constraint, creating and rendering the zoomable image from the video content.

13. The method of claim 12, wherein the acceptable time constraint comprises a period of time in the vicinity of the time in the media at which the designated instruction was received, and wherein the identified still image satisfies the acceptable time constraint it if falls within the period of time.

14. The method of claim 12, wherein the identifying of the still image that most closely corresponds in time to the time in the media at which the designated instruction was received comprises:
selecting the first still image with a time designation later than the time in the media item at which the designated instruction was received;
determining whether the selected first still image is closer in time to the time in the media item at which the designated instruction was received than the still image immediately preceding the selected first still image;
if the selected first still image is closer in time to the time in the media at which the designated instruction was received than the still image immediately preceding the selected first still image, using the selected first still image as the identified still image; and
if the selected first still image is not closer in time to the time in the media at which the designated instruction was received than the still image immediately preceding the selected first still image, using the immediately preceding still image as the identified still image.

15. The method of claim 12, wherein when the zoomable image is created from the video content using an interpolation algorithm.

16. The method of claim 15, wherein the interpolation algorithm comprises:
decoding a reference video frame corresponding to the time in the media item at which the designated instruction was received;
decoding a plurality of video frames temporally adjacent to the reference video frame;
for each decoded temporally adjacent video frame, computing a spatial displacement level relative to the reference video frame;
compensating for the spatial displacement in each decoded temporally adjacent video frame using an enhanced interpolator;
calculating an associated mean squared error for each decoded temporally adjacent video frame; and
selectively discarding decoded temporally adjacent video frames based upon the calculated mean squared error.

17. The method of claim 16, wherein the zoomable image is created and displayed from the video content, and further comprising:
in response to receiving a zooming instruction, calculating a target interpolation factor; and
applying a super-resolution algorithm to create a zoomed version of the zoomable image using the reference frame and each undiscarded decoded temporally adjacent video frame.

18. The method of claim 17, wherein the super-resolution algorithm uses the calculated spatial displacement and mean square error in the undiscarded decoded temporally adjacent video frames to create the zoomed version of the zoomable image.

19. A computer program product, embodied in a computer-readable medium, comprising computer code for performing the processes of claim 12.

20. An apparatus, comprising:
a processor; and
a memory unit communicatively connected to the processor and including:
computer code for, upon receiving a designated instruction during the playing of a media item on a media player, determining whether the media item includes still images in addition to video content;
computer code for, if the media item does not include still images, creating and rendering the zoomable image from the video content;
computer code for, if the media item includes still images,
identifying a still image that most closely corresponds in time to the time in the media item at which the designated instruction was received,
determining whether the identified still image satisfies an acceptable time constraint;
if the identified still image satisfies the acceptable time constraint, rendering the identified still image as the zoomable image; and
if the identified still image does not satisfy the acceptable time constraint, creating and rendering the zoomable image from the video content.

21. The apparatus of claim 20, wherein the acceptable time constraint comprises a period of time in the vicinity of the time in the media at which the designated instruction was received, and wherein the identified still image satisfies the acceptable time constraint it if falls within the period of time.

22. The apparatus of claim 20, wherein the identifying of the still image that most closely corresponds in time to the time in the media at which the designated instruction was received comprises:
selecting the first still image with a time designation later than the time in the media item at which the designated instruction was received;
determining whether the selected first still image is closer in time to the time in the media item at which the designated instruction was received than the still image immediately preceding the selected first still image;
if the selected first still image is closer in time to the time in the media at which the designated instruction was received than the still image immediately 11 preceding the selected first still image, using the selected first still image as the identified still image; and
if the selected first still image is not closer in time to the time in the media at which the designated instruction was received than the still image immediately preceding the selected first still image, using the immediately preceding still image as the identified still image.

23. The apparatus of claim 20, wherein when the zoomable image is created from the video content using an interpolation algorithm.

24. The apparatus of claim 23, wherein the interpolation algorithm comprises:
decoding a reference video frame corresponding to the time in the media item at which the designated instruction was received;
decoding a plurality of video frames temporally adjacent to the reference video frame;
for each decoded temporally adjacent video frame, computing a spatial displacement level relative to the reference video frame;
compensating for the spatial displacement in each decoded temporally adjacent video frame using an enhanced interpolator;
calculating an associated mean squared error for each decoded temporally adjacent video frame; and
selectively discarding decoded temporally adjacent video frames based upon the calculated mean squared error.

25. The apparatus of claim 24, wherein the zoomable image is created and displayed from the video content, and wherein the memory unit further comprises:
computer code for, in response to receiving a zooming instruction, calculating a target interpolation factor; and
computer code for applying a super-resolution algorithm to create a zoomed version of the zoomable image using the reference frame and each undiscarded decoded temporally adjacent video frame.

26. The apparatus of claim 25, wherein the super-resolution algorithm uses the calculated spatial displacement and mean square error in the undiscarded decoded temporally adjacent video frames to create the zoomed version of the zoomable image.

27. A method of using an interpolation algorithm to render a zoomable image from video, comprising:
decoding a reference video frame corresponding to a designated time in a media item;
decoding a plurality of video frames temporally adjacent to the reference video frame;
for each decoded temporally adjacent video frame, computing a spatial displacement level relative to the reference video frame;
compensating for the spatial displacement in each decoded temporally adjacent video frame using an enhanced interpolator;
calculating an associated mean squared error for each decoded temporally adjacent video frame; and
selectively discarding decoded temporally adjacent video frames based upon the calculated mean squared error.

28. The method of claim 27, wherein the zoomable image is created and displayed from the video content, and further comprising:
in response to receiving a zooming instruction, calculating a target interpolation factor; and
applying a super-resolution algorithm to create a zoomed version of the zoomable image using the reference frame and each undiscarded decoded temporally adjacent video frame.

29. The method of claim 28, wherein the super-resolution algorithm uses the calculated spatial displacement and mean square error in the undiscarded decoded temporally adjacent video frames to create the zoomed version of the zoomable image.

30. The method of claim 27, wherein the enhanced interpolator comprises a Gaussian interpolator.

31. A computer program product, embodied in a computer-readable medium, comprising computer code for performing the processes of claim 27.

32. An apparatus, comprising:
a processor; and
a memory unit communicatively connected to the processor and including:
computer code for decoding a reference video frame corresponding to a designated time in a media item;
computer code for decoding a plurality of video frames temporally adjacent to the reference video frame;
computer code for, for each decoded temporally adjacent video frame, computing a spatial displacement level relative to the reference video frame;
computer code for compensating for the spatial displacement in each decoded temporally adjacent video frame using an enhanced interpolator;
computer code for calculating an associated mean squared error for each decoded temporally adjacent video frame; and
computer code for selectively discarding decoded temporally adjacent video frames based upon the calculated mean squared error.

33. The apparatus of claim 32, wherein the zoomable image is created and displayed from the video content, and wherein the memory unit further comprises:
computer code for, in response to receiving a zooming instruction, calculating a target interpolation factor; and
computer code for applying a super-resolution algorithm to create a zoomed version of the zoomable image using the reference frame and each undiscarded decoded temporally adjacent video frame.

34. The apparatus of claim 33, wherein the super-resolution algorithm uses the calculated spatial displacement and mean square error in the undiscarded decoded temporally adjacent video frames to create the zoomed version of the zoomable image.

35. The apparatus of claim 32, wherein the enhanced interpolator comprises a Gaussian interpolator.
